(19) United States
(12) Patent Application Publication
(10) Pub. No.: US 2020/0124160 A1
(43) Pub. Date: Apr. 23, 2020

(54) Transmission Case

(71) Applicant: Ray Shane Jumper, Tyler, TX (US)

(72) Inventor: Ray Shane Jumper, Tyler, TX (US)

(21) Appl. No.: 16/167,602

(22) Filed: Oct. 23, 2018

(51) Int. Cl. F16H 57/029; F16H 57/027; F16H 57/032

(52) U.S. Cl. CPC F16H 57/029; F16H 57/032; F16H 57/027

(57) ABSTRACT

A transmission case that may be suitable for extreme duty scenarios may have a first sidewall, which may include a first sidewall lip and a second sidewall which may include a second sidewall lip. One or more first sidewall fastener apertures may be disposed approximately centrally on the first sidewall lip, and a first sealing groove may be disposed in the first sidewall lip. A second sidewall fastener aperture may be disposed approximately centrally on the second sidewall lip, and a second sealing groove may be disposed in the second sidewall lip. An output shaft housing, having a snorkel interior aperture and a snorkel exterior aperture, may be coupled to a sidewall, such as to the first sidewall. Preferably, each sidewall may be made from billet aluminum alloy.

### FIELD OF THE INVENTION

This patent specification relates to the field of cases for motor vehicle transmissions. More specifically, this patent specification relates to an improved transmission case for motor vehicles that is suitable for extreme duty scenarios.

### BACKGROUND

A transmission, sometimes called a gearbox, is a machine which provides controlled application of the power using gears and gear trains to provide speed and torque conversions from a rotating power source to another device. Many motor vehicles utilize a transmission. However, transmissions can be prone to failure especially when subjected to extreme duty scenarios such as commonly encountered by all-terrain vehicles (ATV), utility task vehicles (UTV), and other off-road motor vehicles. A common area prone to failure is the case of the transmission. Many off-road motor vehicle operators are all too familiar with transmission case damage, such as chipping and fracturing of the snorkel gear tube and the axle output area, which can lead to the entrance of mud and debris into the transmission that may damage and ultimately destroy the transmission. In order to avoid costly repairs and down time, many operators may drive in an over cautious manner that decreases the enjoyment the operators may receive from using their off-road motor vehicles.

Therefore, a need exists for a novel transmission case. A further need exists for a novel transmission case which is vastly superior to resisting damage than existing transmissions and cases. There is also a need for a novel transmission case which can be easily retrofitted to existing off-road motor vehicles.

### BRIEF SUMMARY OF THE INVENTION

A transmission case that may be suitable for extreme duty scenarios is provided. In some embodiments, the case may have a first sidewall, which may include a first sidewall lip and a second sidewall which may include a second sidewall lip. One or more first sidewall fastener apertures may be disposed approximately centrally on the first sidewall lip, and a first sealing groove may be disposed in the first sidewall lip. A second sidewall fastener aperture may be disposed approximately centrally on the second sidewall lip, and a second sealing groove may be disposed in the second sidewall lip. An output shaft housing, having a snorkel interior aperture and a snorkel exterior aperture, may be coupled to a sidewall, such as to the first sidewall. Preferably, each sidewall may be made from billet aluminum alloy.

In further embodiments, the first sidewall lip may include a first exterior perimeter and a first interior perimeter, and the first sidewall may also include a first distance (D1) describing the distance that the first sidewall fastener aperture is from the first exterior perimeter and a second distance (D2) describing the distance that the first sidewall fastener aperture is from the first interior perimeter. Preferably, D1 may be between 90 and 110 percent of D2.

In still further embodiments, the second sidewall lip may include a second exterior perimeter and a second interior perimeter, and the second sidewall may also include a third distance (D3) describing the distance that the second sidewall fastener aperture is from the second exterior perimeter and a fourth distance (D4) describing the distance that the second sidewall fastener aperture is from the second interior perimeter. Preferably, D3 may be between 90 and 110 percent of D4.

In still further embodiments, the first sealing groove and second sealing groove may form a V shape when the first sidewall is coupled to the second sidewall.

In yet further embodiments, the case may include a fastener protrusion and a fastener depression which may be positioned on opposing sidewalls, and the fastener protrusion may be received in the fastener depression when the first sidewall is coupled to the second sidewall. Preferably, the fastener protrusion may have a cylindrical shape that extends around a first sidewall fastener aperture and away from the first sidewall lip.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front elevation view of an example of a transmission case according to various embodiments described herein.

FIG. 2 illustrates a right side elevation view of an example of a transmission case according to various embodiments described herein.

FIG. 3 shows a left side elevation view of an example of a transmission case according to various embodiments described herein.

FIG. 4 depicts a rear elevation view of an example of a transmission case according to various embodiments described herein.

FIG. 5 illustrates a top plan view of an example of a transmission case according to various embodiments described herein.

FIG. 6 shows a bottom plan view of an example of a transmission case according to various embodiments described herein.

FIG. 7 depicts a perspective exploded view of an example of a transmission case according to various embodiments described herein.

FIG. 8 illustrates an elevation interior view of a first sidewall of a view of the back of an example of a transmission case according to various embodiments described herein.

FIG. 9 shows an elevation interior view of a second sidewall of a view of the back of an example of a transmission case according to various embodiments described herein.

FIG. 10 depicts a sectional, through line 10-10 shown in FIG. 8, elevation view of an example of a first sidewall according to various embodiments described herein.

FIG. 11 illustrates a sectional, through line 11-11 shown in FIG. 9, elevation view of an example of a second sidewall according to various embodiments described herein.

FIG. 12 shows a sectional, through line 12-12 shown in FIG. 1, elevation view of an example of a first sidewall coupled to a second sidewall according to various embodiments described herein.

FIG. 13 depicts an enlarged perspective view of the first sidewall shown in FIG. 8.

FIG. 14 illustrates an enlarged perspective view of the second sidewall shown in FIG. 9.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

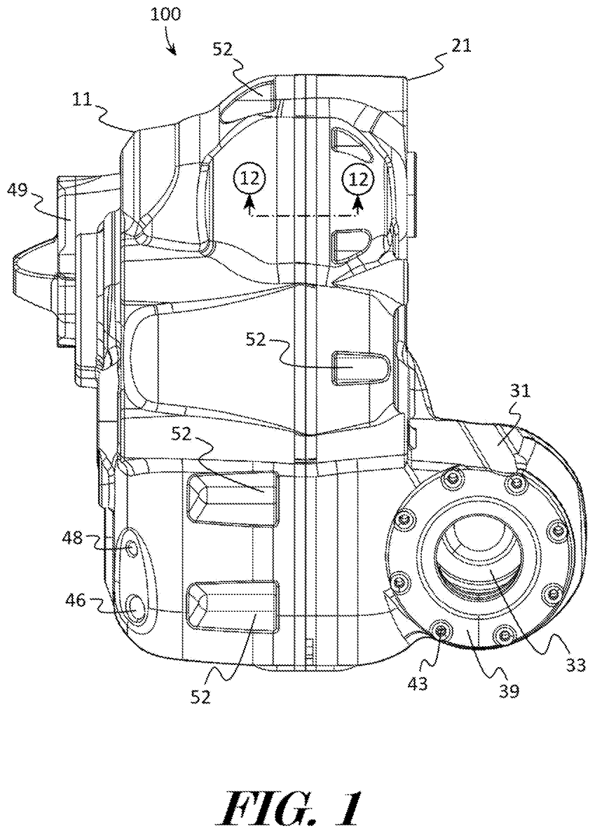

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new transmission case for use with an off-road vehicle is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

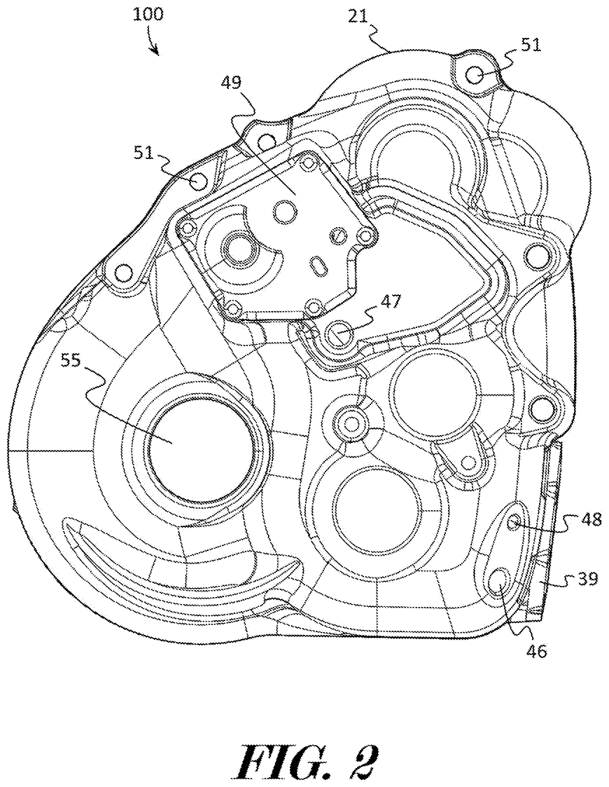

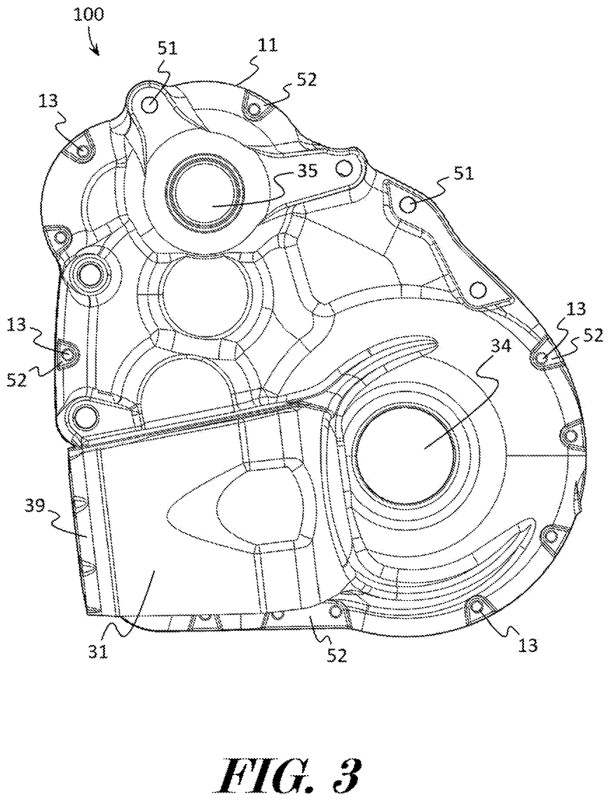

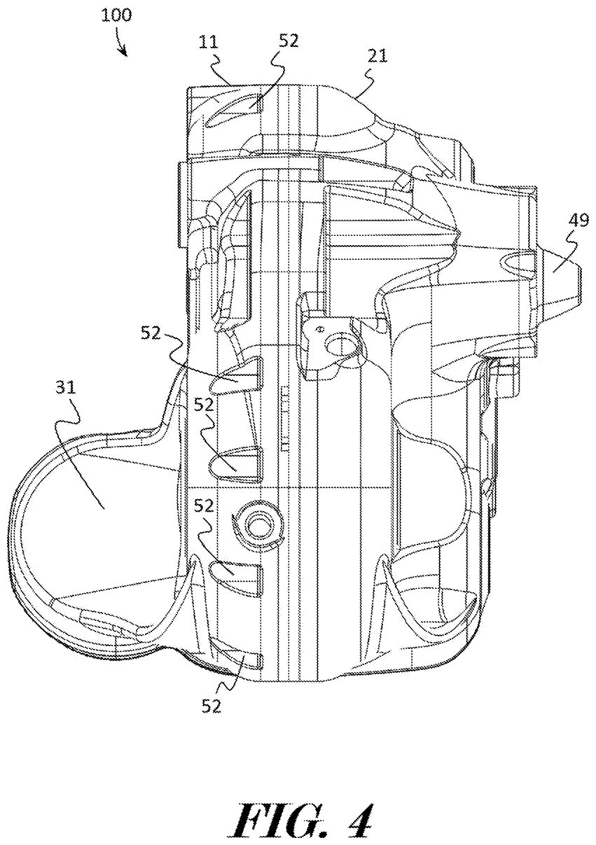

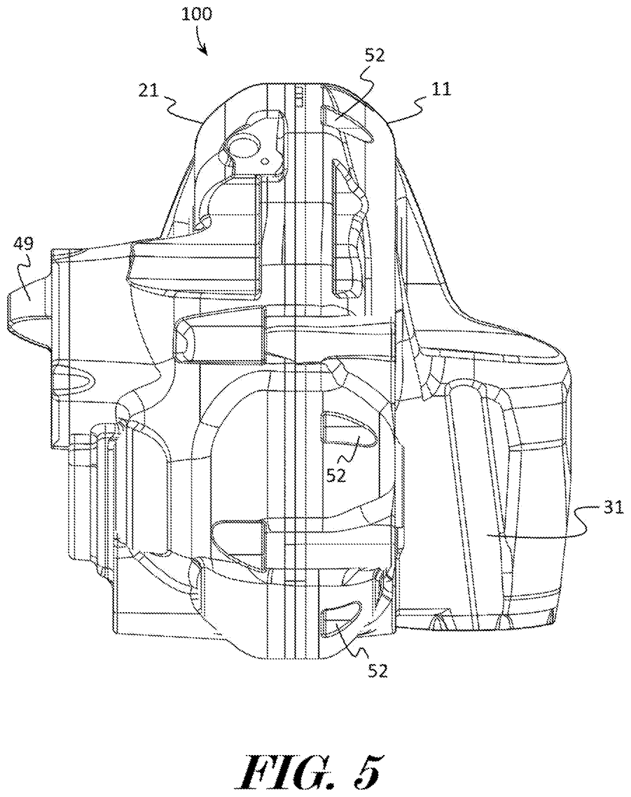

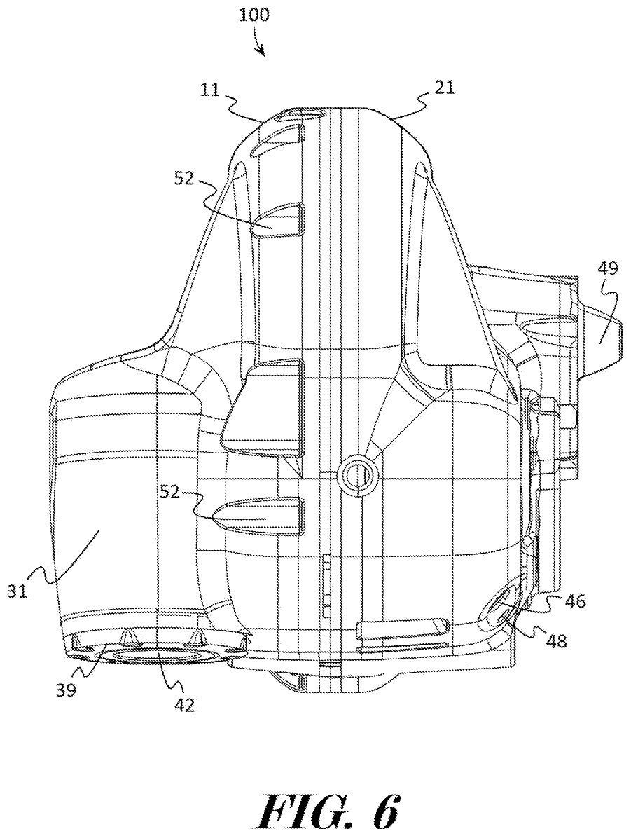

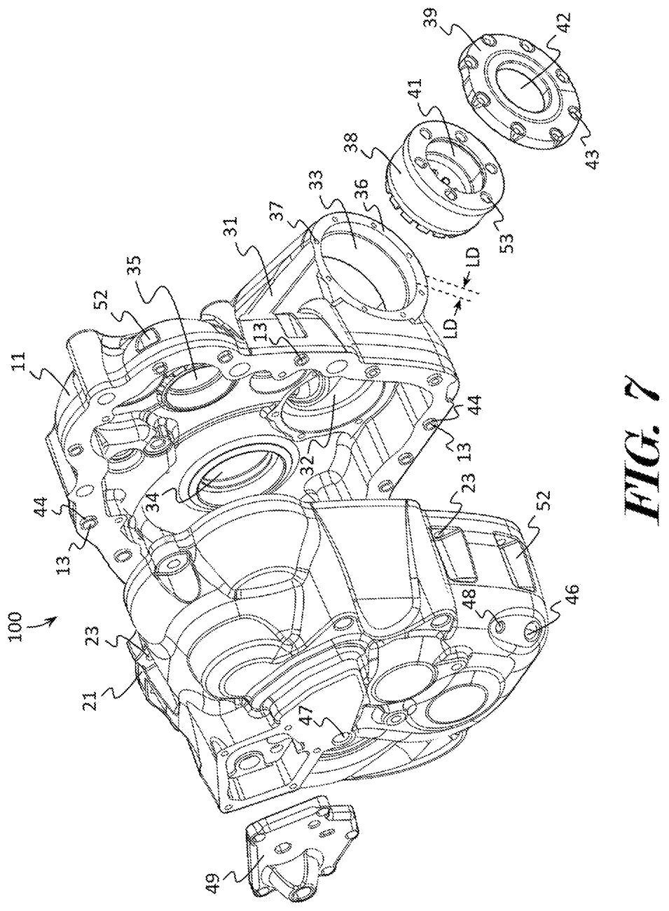

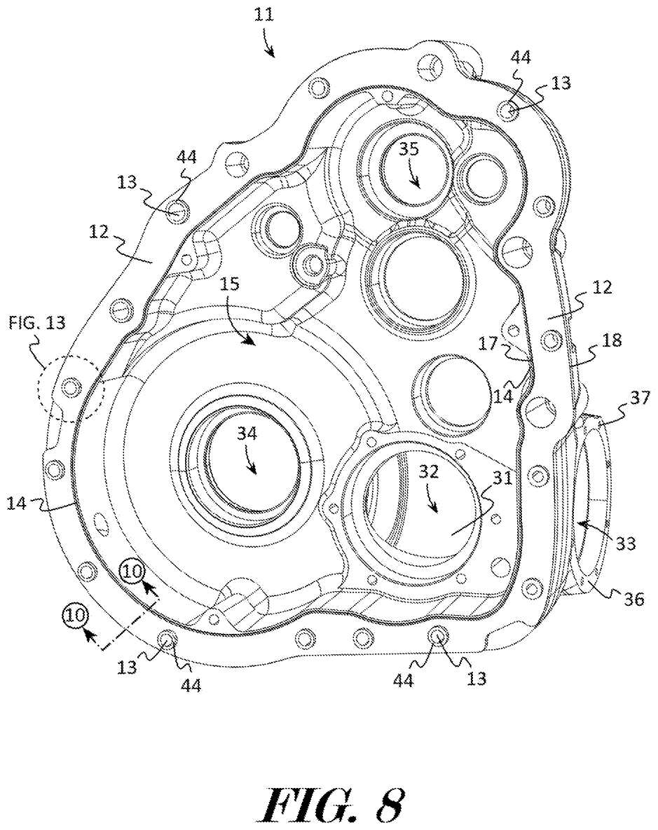

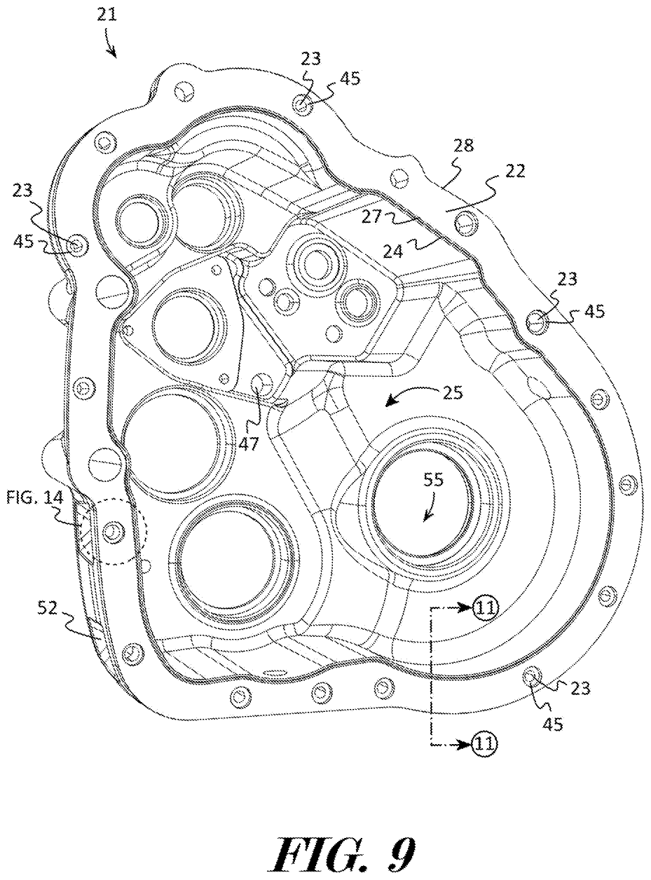

The present invention will now be described by example and through referencing the appended figures representing preferred and alternative embodiments. FIGS. 1-9 illustrate an example of a transmission case (“the case”) 100 according to various embodiments. In some embodiments, the case 100 may comprise a first sidewall 11, which may include a first sidewall lip 12, and a second sidewall 21 which may include a second sidewall lip 22. One or more first sidewall fastener apertures 13 may be disposed approximately centrally on the first sidewall lip 12, and a first sealing groove 14 may be disposed in the first sidewall lip 12. A second sidewall fastener aperture 23 may be disposed approximately centrally on the second sidewall lip 22, and a second sealing groove 24 may be disposed in the second sidewall lip 22. An output shaft housing 31, having a snorkel interior aperture 32 and a snorkel exterior aperture 33, may be coupled to a sidewall, such as to the first sidewall 11.

The first sidewall 11 may comprise an interior surface 15 and an exterior surface 16 which may meet at the first sidewall lip 12 so that the first sidewall 11 may terminate at the first sidewall lip 12. Likewise, the second sidewall 21 may comprise an interior surface 25 and an exterior surface 26 which may meet at the second sidewall lip 22 so that the second sidewall 21 may terminate at the second sidewall lip 22. Generally, the sidewalls 11, 21, may be coupled together so that all or portions of the first sidewall lip 12 and second sidewall lip 22 may be brought into contact with each other so that a cavity may be formed between the interior surfaces 15, 25, of the sidewalls 11, 21, that is suitable for containing the gears, other elements, and transmission fluid or oil that may be used by an off-road vehicles, such as all-terrain vehicles (ATV), utility task vehicles (UTV), and other off-road motor vehicles. The size and shape of the sidewalls 11, 21, may be altered to accommodate any desired gears and related elements as needed for any desired transmission setup.

In some embodiments, a first sidewall 11 may include an output shaft housing 31, an axle output aperture 34, and an input shaft aperture 35. Preferably, an axle output aperture 34 may be generally circular in shape so as to accommodate a power output element such as a final drive to axle output. Similarly, an input shaft aperture 35 preferably may be generally circular in shape so as to accommodate a power input element such as an input shaft from the power source or engine. In further embodiments, a second sidewall 21 may comprise a second sidewall case aperture 55 which may be shaped and configured to receive a drive shaft or other component of a transmission. It should be understood that the case 100 may comprise any number of apertures 34, 35, 55, 32, 33, that may be sized, shaped, and positioned to accommodate elements of any transmission layout.

An output shaft housing 31 may include a snorkel interior aperture 32 and a snorkel exterior aperture 33 which both may be generally circular in shape. In preferred embodiments, a snorkel interior aperture 32 and a snorkel exterior aperture 33 may be approximately perpendicularly oriented relative to each other, while the snorkel interior aperture 32 may be oriented approximately parallel to the axle output aperture 34 and input shaft aperture 35. In further preferred embodiments, the snorkel interior aperture 32, axle output aperture 34, and input shaft aperture 35 may be oriented in a generally triangular configuration with the interior aperture 32 positioned generally between the axle output aperture 34, and the input shaft aperture 35 positioned generally above the axle output aperture 34, snorkel interior aperture 32, and snorkel exterior aperture 33. In other embodiments, a snorkel interior aperture 32, snorkel exterior aperture 33, axle output aperture 34, and input shaft aperture 35 may be positioned in any other orientation relative to each other. In preferred embodiments, a snorkel exterior aperture 33 of the case 100 may comprise a circular shape having a diameter that is between approximately 1.0 and 35 percent larger than the corresponding aperture or opening on currently available transmission cases. In further preferred embodiments, a snorkel exterior aperture 33 of the case 100 may comprise a circular shape having a diameter that is between approximately 5.0 and 20 percent larger than the corresponding aperture or opening on currently available transmission cases. Since currently available transmission cases are limited to using spiral bevel gear arrangements having a thirteen tooth spiral bevel gear, the larger snorkel exterior aperture 33 allows the case 100 to accommodate larger spiral bevel gear arrangements having a spiral bevel gear with greater than thirteen for increased strength and durability over currently available transmission cases.

An output shaft housing 31 may include a snorkel lip 36 which may surround the snorkel exterior aperture 33. In preferred embodiments, the snorkel lip 36 may comprise a length dimension (LD) of between approximately 6.0 to 20.0 millimeters, and more preferably between approximately 10.0 to 15.0 millimeters. In further embodiments, one or more snorkel fastener apertures 37 may be disposed on the snorkel lip 36. Generally, a snorkel fastener aperture 37 may comprise a threaded aperture suitable for receiving a threaded fastener such as a bolt, threaded stud, screw, or the like. In further embodiments, the snorkel exterior aperture 33 may be disposed between at least two snorkel fastener apertures 37. In further preferred embodiments, the snorkel exterior aperture 33 may be disposed between at three, four, five, six, seven, eight, nine, ten, or more snorkel fastener apertures 37 so that the snorkel exterior aperture 33 may be generally surrounded by the snorkel fastener apertures 37.

In some embodiments, the device 100 may comprise an output shaft adjustment component (moch) 38 which may be positioned in the snorkel exterior aperture 33 and retained therein via an output shaft seal cap 39. An output shaft adjustment component (moch) 38 may comprise one or more moch fastener apertures 53 which may receive fasteners that may be used to couple elements of the output shaft adjustment component (moch) 38 together. Preferably, an output shaft adjustment component (moch) 38 may include reinforced bearing journals. Optionally, an output shaft adjustment component (moch) 38 may have one or less seals. As well it doesn't retail the 2 seals as stock. Preferably, an output shaft adjustment component (moch) 38 may be generally annular or cylindrical shaped having a centrally positioned cylindrically shaped moch aperture 41 suitable for receiving portions of a cylindrically shaped output shaft. Similarly, an output shaft seal cap 39 may include a circular or cylindrical shaped cap aperture 42 which may be aligned with the moch aperture 41 when the output shaft adjustment component (moch) 38 is coupled within the snorkel exterior aperture 33 by the output shaft seal cap 39. An output shaft seal cap 39 may include one or more seal apertures 43, preferably corresponding to the number of snorkel fastener apertures 37, and which may be aligned with the snorkel fastener apertures 37 of the snorkel lip 36. In some embodiments, an output shaft seal cap 39 may include a single seal.

Generally, a seal aperture 43 may comprise an aperture suitable for receiving a threaded fastener such as a bolt, threaded stud, screw, or the like which may be received in both the seal aperture 43 and a snorkel fastener aperture 37. In further embodiments, the cap aperture 42 may be disposed between at least two seal apertures 43. In further preferred embodiments, the cap aperture 42 may be disposed between at three, four, five, six, seven, eight, nine, ten, or more seal apertures 43 so that the cap aperture 42 may be generally surrounded by the seal apertures 43.

The sidewalls 11, 21, may be made from or may comprise any substantially durable material which may be suitable for transmission and combustion engine applications. In preferred embodiments, the sidewalls 11, 21, and/or other elements described herein may be made from or may comprise billet aluminum alloy and the elements of the sidewalls 11, 21, may be formed by a milling process such as a CNC (Computer Numeric Control) milling machine. In further preferred embodiments, the sidewalls 11, 21, may be made from or may comprise 6061-T6 billet extruded aluminum plate. In further embodiments, the sidewalls 11, 21, may be made from or may comprise an aluminum 6000 series alloy, aluminum 7000 series alloy, aluminum 5000 series alloy, or any other aluminum alloy. In alternative embodiments, the sidewalls 11, 21, may be made from or may comprise steel alloy, zinc alloy, magnesium alloy, or any other metal or metal alloy. In further alternative embodiments, the sidewalls 11, 21, and/or other elements described herein may be made via a molding process, welding process, or any other suitable process for forming metal elements.

In some embodiments, one or both sidewalls 11, 21, and/or other elements described herein may comprise a thickness dimension which may describe the minimum distance between the interior surface 15, 25, and exterior surface 16, 26, of a respective sidewall 11, 21. In preferred embodiments, the first sidewall 11 may comprise a first thickness dimension (TD1) that may describe the minimum distance between the interior surface 15 and exterior surface 16 and that may be between approximately 20 to 30 millimeters and more preferably between 22 to 26 millimeters. In further preferred embodiments, the second sidewall 21 may similarly comprise a second thickness dimension (TD2) that may describe the minimum distance between the interior surface 25 and exterior surface 26 and that may be between approximately 20 to 30 millimeters and more preferably between 22 to 26 millimeters.

The first sidewall lip 12 of the first sidewall 11 may comprise a first interior perimeter 17 which may couple the interior surface 15 to the first sidewall lip 12, and a first exterior perimeter 18 which may couple the exterior surface 16 to the first sidewall lip 12. Likewise, the second sidewall lip 22 of the second sidewall 21 may comprise a second interior perimeter 27 which may couple the interior surface 25 to the second sidewall lip 22, and a second exterior perimeter 28 which may couple the exterior surface 26 to the second sidewall lip 22.

In some embodiments, the sidewall lips 12, 22, of the sidewalls 11, 21, may comprise a width dimension which may describe the minimum distance between the interior perimeter 17, 27, and exterior perimeter 18, 28, of a respective sidewall 11, 21. In preferred embodiments, the first sidewall lip 12 may comprise a first width dimension (WD1) that may describe the minimum distance between the interior perimeter 17 and exterior perimeter 18 and that may be between approximately 20 to 30 millimeters and more preferably between 22 to 26 millimeters. In further preferred embodiments, the second sidewall lip 22 may similarly comprise a second width dimension (WD2) that may describe the minimum distance between the interior perimeter 27 and exterior perimeter 28 and that may be between approximately 20 to 30 millimeters and more preferably between 22 to 26 millimeters. In further preferred embodiments, WD1 may be between approximately 70 to 130 percent, and more preferably between 90 and 110 percent of TD1. In still further preferred embodiments, WD2 may be between approximately 70 to 130 percent, and more preferably between 90 and 110 percent of TD2.

The case 100 may comprise one or more sidewall fastener apertures, such as a first sidewall fastener apertures 13 and second sidewall fastener apertures 23. Generally, a sidewall fastener aperture 13, 23, may comprise an aperture suitable for receiving a threaded fastener such as a bolt, threaded stud, screw, or the like which may be used to removably couple the first sidewall 11 to the second sidewall 21 so that the first sidewall lip 12 and second sidewall lip 22 are brought proximate to or into contact with each other. In preferred embodiments, a sidewall fastener aperture 13, 23, may be disposed generally centrally (approximately equidistant to the interior perimeter 17, 27, or exterior perimeter 18, 28, of its respective sidewall lip 12, 22) on its respective sidewall lip 12, 22. In other embodiments, a sidewall fastener aperture 13, 23, may be disposed closer to either the interior perimeter 17, 27, or exterior perimeter 18, 28, of its respective sidewall lip 12, 22.

In some embodiments, the first sidewall lip 12 of the first sidewall 11 may comprise a first distance (D1) that may describe the distance that a first sidewall fastener aperture 13 may be from the first exterior perimeter 18 and a second distance (D2) that may describe the distance that the first sidewall fastener aperture 13 may be from the first interior perimeter 17. In preferred embodiments, D1 may be between approximately 80 and 120 percent of D2 and more preferably between 90 and 110 percent of D2. In further embodiments, the second sidewall lip 22 of the second sidewall 21 may comprise a third distance (D3) that may describe the distance that a second sidewall fastener aperture 23 may be from the second exterior perimeter 28 and a fourth distance (D4) that may describe the distance that the second sidewall fastener aperture 23 may be from the second interior perimeter 27. In preferred embodiments, D3 may be between approximately 80 and 120 percent of D4 and more preferably between 90 and 110 percent of D4.

In some embodiments, the case 100 may comprise one or more fastener protrusions 44 and fastener depressions 45 which may be disposed anywhere on a first sidewall lip 12 and/or a second sidewall lip 22 and which may be aligned with each other when the sidewalls 11, 21, are coupled together. Generally, a fastener protrusion 44 may extend above or away from a sidewall lip 12, 22, and a fastener depression 45 may extend below or into a sidewall lip 12, 22, so that the fastener protrusion 44 may be received in the fastener depression 45. Preferably, a fastener protrusion 44 and its respective fastener depression 45 may be configured with complementary shapes so that the fastener protrusion 44 may fit snuggly into its respective fastener depression 45 so that the fastener protrusion 44 and fastener depression 45 may prevent the sidewalls 11, 21, from sliding apart or otherwise being misaligned. For example, a fastener protrusion 44 may comprise a pyramid shaped protrusion and its respective fastener depression 45 may comprise a similarly sized pyramid shaped protrusion depression. As another example, a fastener protrusion 44 may comprise a rectangular prism shaped protrusion and its respective fastener depression 45 may comprise a similarly sized rectangular prism shaped protrusion depression. However, it should be understood that fastener protrusions 44 and fastener depressions 45 may be configured in any shape and size.

In some embodiments, a fastener protrusion 44 and fastener depression 45 may be positioned proximate to or in contact with a sidewall fastener aperture 13, 23, on their respective sidewall lip 12, 22. For example, a fastener protrusion 44 may comprise a tubular or hollow cylindrical shaped protrusion that surrounds and extends above a sidewall fastener aperture 13, 23, while a fastener depression 45 may comprise a cylindrical shaped depression that surrounds and extends down along portions of the fastener depression 45.

In preferred embodiments, a first sidewall lip 12 may comprise a fastener protrusion 44 and a second sidewall lip 22 may comprise a fastener depression 45, and the fastener protrusion 44 may comprise a cylindrical shape that extends around a first sidewall fastener aperture 13 and away from the first sidewall lip 12. The fastener depression 45 may comprise a cylindrical shaped depression that surrounds and extends down along portions of the fastener depression 45, and when the first sidewall 11 is coupled to the second sidewall 21, the fastener protrusion 44 of the first sidewall lip 12 may be received in the fastener depression 45 of the second sidewall lip 22.

In further preferred embodiments, a first sidewall lip 12 may comprise a fastener depression 45 and a second sidewall lip 22 may comprise a fastener protrusion 44, and the fastener protrusion 44 may comprise a cylindrical shape that extends around a second sidewall fastener aperture 23 and away from the second sidewall lip 22. The fastener depression 45 may comprise a cylindrical shaped depression that surrounds and extends down along portions of the fastener depression 45, and when the first sidewall 11 is coupled to the second sidewall 21, the fastener protrusion 44 of the second sidewall lip 22 may be received in the fastener depression 45 of the first sidewall lip 12.

In some embodiments, the case 100 may comprise one or more sealing grooves, such as a first sealing groove 14 and a second sealing groove 24. Generally, a first sealing groove 14 may be disposed anywhere in the first sidewall lip 12, and a second sealing groove 24 may be disposed anywhere in the second sidewall lip 22. Preferably, a first sealing groove 14 and a second sealing groove 24 may be aligned so as to be brought proximate to or in contact with portions of each other when the sidewalls 11, 21, are coupled together. In preferred embodiments, a first sealing groove 14 may be disposed in the first sidewall lip 12 by being coupled to the first interior perimeter 17, and a second sealing groove 24 may be disposed in the second sidewall lip 22 by being coupled to the second interior perimeter 27. In further embodiments, a first sealing groove 14 and a second sealing groove 24 may extend along the entire length of their respective sidewall lip 12, 22.

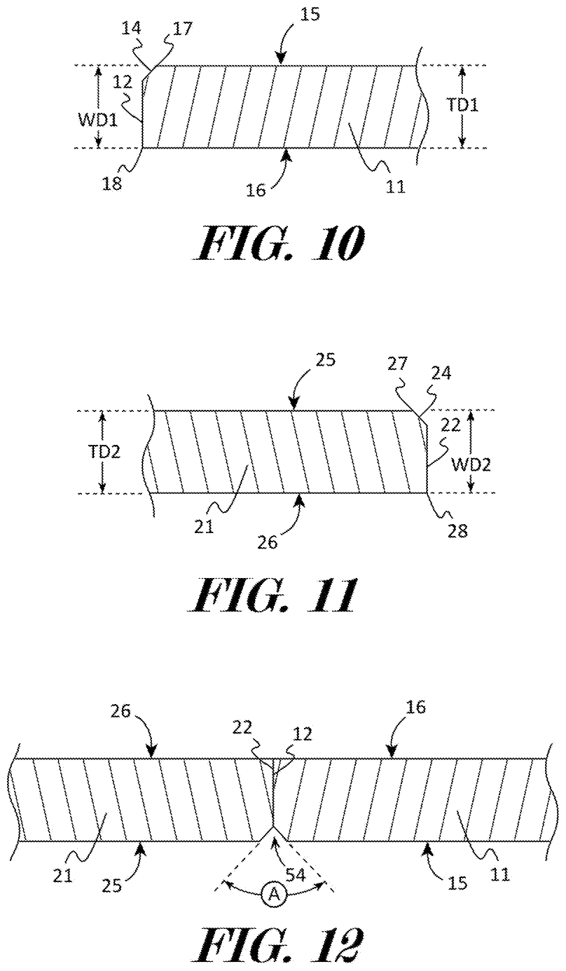

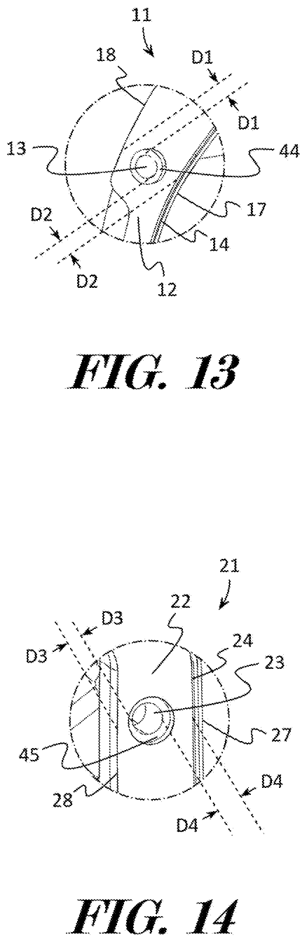

A first sealing groove 14 and a second sealing groove 24 may be configured in any shape and size. In preferred embodiments, a first sealing groove 14 may be angled away from the first sidewall lip 12 and/or first interior perimeter 17 towards the interior surface 15. In further preferred embodiments, a second sealing groove 24 may be angled away from the second sidewall lip 22 and/or second interior perimeter 27 towards the interior surface 25. In still further preferred embodiments, the case 100 may comprise a first sealing groove 14 and a second sealing groove 24 and each sealing groove 14, 24, may be angled away from its respective sidewall lip 12, 22, and/or interior perimeter 17, 27, so that the first sealing groove 14 and second sealing groove 24 may form a V shape 54 when the first sidewall 11 is coupled to the second sidewall 21 as shown in FIG. 12. In further embodiments, a first sealing groove 14 may be angled away from a second sealing groove 24 by between approximately 30 degrees to 150 degrees as shown by angle A.

In some embodiments, a case 100 may include a shift tower plate 49 which may be optionally coupled to the second sidewall 21. Preferably, a shift tower plate 49 may be removably coupled to the second sidewall 21. In further embodiments, the shift tower plate 49 may be made from billet aluminum alloy of between approximately 20 to 30 millimeters and more preferably between 22 to 26 millimeters in thickness. In still further embodiments, the case 100 may comprise one or more mounting apertures 51 which may receive a fastener that may be used to couple the case 100 to an object such as a motor, vehicle, etc. In preferred embodiments, one or both sidewalls 11, 21, may comprise one or more recessed bolt pockets 52 each of which may be aligned with a sidewall fastener aperture 13, 23. A recessed bolt pocket 52 may comprise a depression formed into a sidewall 11, 21, that may allow portions of the head of a bolt type fastener received in a sidewall fastener aperture 13, 23, to rest against the recessed bolt pocket 52.

In some embodiments, the case 100 may comprise a pickup aperture 46 and a return aperture 47 which may each extend through a sidewall 11, 21. Preferably, a pickup aperture 46 and a return aperture 47 may be disposed in the second sidewall 21. A pickup aperture 46 and a return aperture 47 may each be configured to receive a coupling which may allow oil or transmission fluid to be removed from the case 100 via the pickup aperture 46, communicated to an oil or transmission cooler, and then returned into the case 100 via the return aperture 47. A pickup aperture 46 and a return aperture 47 may be positioned anywhere on the case 100. In preferred embodiments, a pickup aperture 46 may be positioned relatively lower on the case 100 (relatively closer to a sidewall lip 12, 22) and a return aperture 47 may be positioned relatively centrally or higher on the case (relatively further from a sidewall lip 12, 22).

In some embodiments, the case 100 may comprise a sensor aperture 48 which may optionally extend into or through a sidewall 11, 21. Generally, a sensor aperture 48 may be configured to receive portions of a temperature sensor which may be used to provide temperature data describing the case 100 during use. A sensor aperture 48 may be positioned anywhere on the case 100. In preferred embodiments, a sensor aperture 48 may be positioned proximate to a pickup aperture 46.

While some exemplary shapes and sizes have been provided for elements of the case 100, it should be understood to one of ordinary skill in the art that the first sidewall 11, second sidewall 12, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the case 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the case 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the case 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the case 100 may be coupled by being one of connected to and integrally formed with another element of the case 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A transmission case, the case comprising:
a first sidewall, the first sidewall terminating at a first sidewall lip;
a first sidewall fastener aperture disposed on the first sidewall lip;
a first angled edge disposed in the first sidewall lip;
a second sidewall, the second sidewall terminating at a second sidewall lip;
a second sidewall fastener aperture disposed on the second sidewall lip;
a second angled edge disposed in the second sidewall lip;
an output shaft housing positioned on the first sidewall;
a pickup aperture located on the second sidewall;
a return aperture located on the second sidewall;
a sensor aperture located on the second sidewall and configured to receive a temperature sensor; and
wherein the pickup aperture, the return aperture, and the sensor aperture are all positioned along a common surface of the second sidewall.

2. (canceled)

3. (canceled)

4. The case of claim 1, wherein the first angled edge and second angled edge form a V-shape when the first sidewall is coupled to the second sidewall.

5. The case of claim 1, wherein the first sidewall lip comprises a fastener protrusion, wherein the second sidewall lip comprises a fastener depression, and wherein the fastener protrusion is received in the fastener depression when the first sidewall is coupled to the second sidewall.

6. The case of claim 5, wherein the fastener protrusion comprises a cylindrical shape that extends around the first sidewall fastener aperture and away from the first sidewall lip.

7. The case of claim 1, wherein the first sidewall lip comprises a fastener protrusion, wherein the second sidewall lip comprises a fastener depression, and wherein the fastener protrusion is received in the fastener depression when the first sidewall is coupled to the second sidewall.

8. The case of claim 7, wherein the fastener protrusion comprises a cylindrical shape that extends around the first sidewall fastener aperture and away from the first sidewall lip.

9. The case of claim 1, wherein a sidewall selected from the group consisting of the first sidewall and the second sidewall is made from billet aluminum alloy.

10. The case of claim 1, wherein a sidewall selected from the group consisting of the first sidewall and the second sidewall comprises a thickness dimension, and wherein the thickness dimension is between 20 to 30 millimeters.

11. The case of claim 1, wherein a sidewall lip selected from the group consisting of the first sidewall lip and the second sidewall lip comprises a width dimension, and wherein the width dimension is between 20 to 30 millimeters.

12. (canceled)

13. (canceled)

14. (canceled)

15. The case of claim 1, further comprising an output shaft seal cap.
